(19) United States
(12) Patent Application Publication
(10) Pub. No.: US 2011/0051445 A1
(43) Pub. Date: Mar. 3, 2011

(54) Vehicle Rear Lamp Assembly with CCFL

(76) Inventor: KENG-CHIN YEH, Taipei (TW)

(21) Appl. No.: 12/551,587

(22) Filed: Sep. 1, 2009

(51) Int. Cl. F21V 1/00

(52) U.S. Cl. 362/509

(57) ABSTRACT

A vehicle rear lamp assembly of a pre-determined shape includes one or more CCFL, electric wires extending from the CCFL and meet at a point to form a circuit loop. A plurality of soft positioning bands secure to CCFL electric wires which are around CCFL. A soft shock-proof sleeve is added to further secure electric wires to CCFL at the ends of CCFL.

### BACKGROUND OF THE INVENTION

1. Field of Invention

The present invention relates to a vehicle lamp assembly with one or more CCFL, and more particularly, to a vehicle rear lamp assembly, of which the size and shape are customized to those of CCFL (Cold Cathode Fluorescent Lamp) contained within, and which is reliably positioned in a desired illuminating position through easy operation of a few parts only.

2. Description of Prior Arts

Common vehicle lamps containing LCD are quite popular in the market. Some vehicle lamps seen in the market have lamp shades, of which the size and shape are pre-determined in manufacturing and hence allow for little varieties in size and shape of the lights to be contained within. While some other vehicle lamps in the market are made to adapt to the shape of vehicle lamp seats to be installed in.

### BRIEF SUMMARY OF THE INVENTION

The main purpose of this invention is to provide a vehicle rear lamp containing one or more CCFL; two wires extending out from the CCFL meet at a point to form a circuit loop. A plurality of positioning bands are used to secure to CCFL the electric wires around CCFL. CCFL in the lamp assembly is completely covered by a lamp shade, the size and shape of which are made to correspond to those of CCFL to be contained within.

Preferably, a soft shock-proof sleeve is applied to further secure electric wires to CCFL at the two ends thereof.

Preferably, the lamp shade that covers CCFL contained in the lamp assembly has an outer layer in the shape of a series of connecting convexes or concaves.

Preferably, the lamp shade that covers CCFL contained in the lamp assembly has an inner layer in the shape of a series of convexes or concaves.

Preferably, the lamp assembly with CCFL is applied to all kinds of vehicle lights including directional lights, brake lights, blinker lights, etc.

### BRIEF DESCRIPTION OF DRAWINGS

FIG. 1 is a perspective front view of a preferred embodiment of a vehicle rear lamp assembly of this invention.

FIG. 2 is a perspective view of the CCFL and the lamp shade before assembling.

FIG. 3 is a side view of the CCFL and an enlarged view of a part of CCFL.

FIG. 4 is a detailed cross-sectional view of a preferred embodiment without a lamp shade.

FIG. 5 shows the disclosed vehicle lamp assembly installed in the lamp seat of a vehicle when the light is turned on.

### DETAILED DESCRIPTION OF DRAWINGS

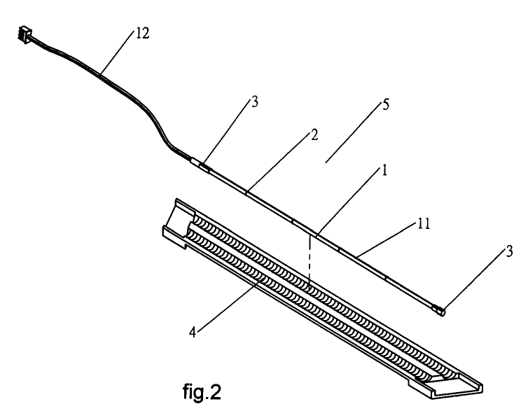

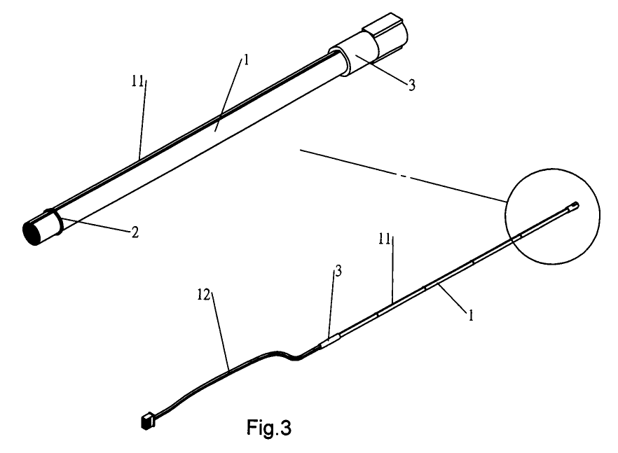

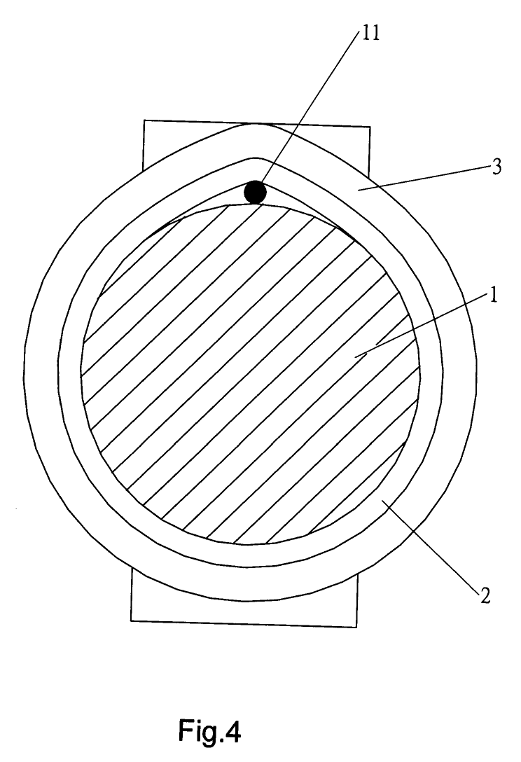

Referring to FIG. 2, the vehicle rear lamp assembly 5 with a pre-determined shape, which includes one or more CCFL and a lamp shade. Whereas, the shape or appearance of one or more CCFL is chosen to correspond to those of the vehicle back lamp assembly 5. Electric wires 11 extend from the ends of the CCFL 1 and meet at the end-meet point 12 to form a circuit loop. A plurality of positioning band 2 are used to secure to CCFL 1 the electric wires 11 around CCFL, as shown by FIG. 3 and FIG. 4. Also a soft shock-proof sleeve 3 is applied to further secure electric wires 11 at the two ends of CCFL 1.

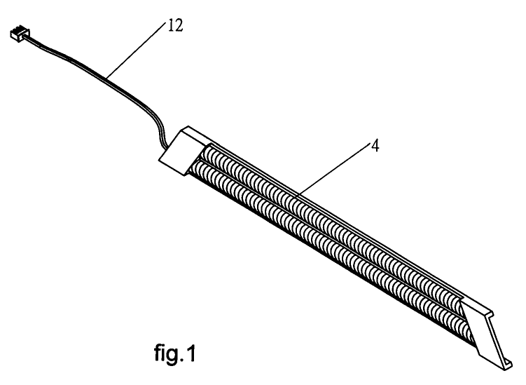

A lamp shade 4 is a protective cover for CCFL 1, both the size and the shape of which are determined by the number and overall shape of all CCFL's contained in CCFL 1 in the assembly; the color of the lamp shade 4 could be either transparent or any colors, depending on designing favors. The outside layer of the lamp shade can be in the shape of one or more series of connecting convexes or concaves, as shown in FIG. 1. Or alternatively, the inside layer of the lamp shade 4 can be in the shape of a series of connecting convexes or concaves, as shown in FIG. 2, for CCFL 1 to have a different positioning.

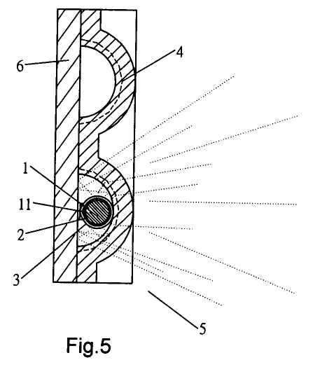

Please refer to FIG. 2 and FIG. 5 for actual assembly. A preferred embodiment of lamp assembly 5 of this invention includes electric wires 11 extended from the two ends of one CCFL 1, a lamp shade 4, and an end-meet point 12 where the electric wires 11 meet, which makes a circuit loop.

The lamp assembly 5 is then installed in the rear lamp seat of a vehicle. The lamp shade 4 is finally applied to the lamp assembly 5 as a protective cover for CCFL 1 contained inside.

The lamp assembly 5 disclosed in this invention can be applied to the directional lights, brake lights, blinking lights etc. for all kinds of vehicles.

Advantages associated with the above lamp assembly include the following:
1. Better light emitting effect in cloudy days or days with dim light;
2. Better light collecting effect;
3. Depending upon the shape of CCFL contained, the lamp assembly disclosed can be of any shapes determined by specific purposes of lighting required by vehicles.

I claim:

1. A vehicle rear lamp assembly, comprising:
one or more CCFL,
electric wires extending from said CCFL which meet to form a circuit loop,
an end-meet point, where said electric wires meet,
a plurality of positioning bands to secure said electric wires to said CCFL, and
a lamp shade to cover said CCFL.

2. A vehicle rear lamp assembly as claimed in claim 1, further comprising a soft shock-proof sleeve to secure said electric wires to said CCFL at the two ends thereof.

3. A vehicle rear lamp assembly as claimed in claim 1, further comprising a lamp shade including an outer layer in the shape of a series of connecting convexes or concaves.

4. A vehicle rear lamp assembly as claimed in claim 1, further comprising a lamp shade including an inner layer in the shape of a series of connecting convexes or concaves.

5. A vehicle rear lamp assembly as claimed in claim 1, which is customized to fit into the lamp seat for directional lights, blinker lights, and brake lights of vehicles.
